(19) United States
(12) Patent Application Publication
(10) Pub. No.: US 2006/0047810 A1
(43) Pub. Date: Mar. 2, 2006

(54) Asset management system and method

(76) Inventors: Kyle Herzog, Sioux City, IA (US); Jackie Leshko, San Diego, CA (US); Ren Mackey, Sioux Falls, SD (US); Juan Harrington, Sioux Falls, SD (US); Steven Berrett, San Diego, CA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/932,459

(22) Filed: Sep. 2, 2004

(51) Int. Cl. G06F 15/173

(52) U.S. Cl. 709/224

(57) ABSTRACT

A computer asset management system permits users of computing devices to run a system profiler tool on their computing device, and an inventory of the computing device's assets are uploaded to a database specific to the organization to which the computing device belongs. An IT manager from the organization can be associated with the organization-specific database, who can then review and track all the computer assets of the organization through the database. The profiler tool preferably runs on browser software, as does the asset database presentation tools that are available to the IT manager.

### BACKGROUND OF THE INVENTION

1. Field of the Invention

The present invention relates to devices, systems, and processes useful in computer and software asset management, and more particularly in asset management for groups of computing devices.

2. Brief Description of the Related Art

Users and owners of multiple computing devices have desired a low-cost, low-administration method to track the inventory of systems they support. Prior asset management systems, however, do not provide a current system inventory, but rather provide “as-shipped” configuration information which can quickly become inaccurate. Theses systems also require that the person, group of persons, or software charged with the responsibility of tracking and maintaining the computing devices (“IT Manager”) knows the Client ID or Order number for each computing device, which is oftentimes not readily available to an IT Manager.

Some prior suggestions in the general area do not provide solutions which adequately serve the IT Manager. U.S. Pat. No. 6,446,046 B1 describes a sentinel that inspects a user's computer via code imbedded in a webpage, and determines upgrades or changes to the user's computer based on this inspection. U.S. Pat. No. 6,366,930 B1 describes a system for monitoring the version of electronic files on a computer, and restoring the files to previous versions. U.S. Pat. No. 6,327,617 B1 describes a software update system that queries an update server for newer versions of software present on the user's computer, and downloads and installs the newer versions on the user's computer.

There remains a need for a system and method which facilitates the harvesting of information about computing devices, and more preferably about groups of computing devices that are owned by or part of a larger organization, and facilitates central asset management of these devices.

### SUMMARY OF THE INVENTION

According to a first aspect of the invention,

According to another aspect of the present invention,

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 schematically illustrates an exemplary embodiment of a system and method in accordance with the present invention.

FIG. 2 diagrammatically illustrates an exemplary process flow in accordance with the present invention.

FIG. 3 diagrammatically illustrates another exemplary process flow in accordance with the present invention.

### DESCRIPTION OF THE PREFERRED EMBODIMENTS

Referring to the drawing figures, like reference numerals designate identical or corresponding elements throughout the several figures.

In the context of the present invention, the term ‘software’ includes, but is not limited to, software stored in hardware devices in non-volatile, non-mass storage memory, as well as that stored in mass-storage devices.

Asset Management (AM) is a broad term used to describe applications that provide users of computing devices, e.g., PCs, PDAs (personal digital assistants, e.g., Palm, Handspring, Sony, etc. brand handheld computing devices), mobile telephones, printers, and the like, with the ability to manage their computer's assets via a web site. Asset Management includes, but is not limited to within the context of the present invention, several activities: capturing system inventory; storing inventory data; providing query/report capabilities; and linking inventory with related web content and upgrade information.

One broad aspect of the present invention is an Asset Management System (AMS) that is capable of capturing workstation user and advanced configuration (e.g., hardware, software, system resources) settings of the user's computing device, and harvest this information for review by one or more IT managers of a business customer through a secure site. According to a preferred embodiment of the present invention, at least some of this functionality will utilize a profiler tool that is downloaded to the user's computing device. One particularly suitable profiler tool, although the present invention is not restricted to it, includes an Active X control profiler tool currently available by PC Pit Stop (pc-pitstop.com). A profiler according to the present invention is preferably embodied in an object that resides on the workstation user's computing device, e.g., code embedded in a webpage and scripted in a preferably platform independent coding format, e.g., Java, JavaScript, visual basic, Java applet, Active-X, and the like, and which interacts with other computing devices through an attached network. Alternatively, the profiler tool can be embodied in an agent that is launched at boot up, launched manually, or launched during execution of a login script. Those of ordinary skill in the art are very well acquainted with the build and operation of such profiler tools, and therefore further details will not be included herein so as not to obscure the present invention.

System configuration information will be harvested by the profiler through a workstation (computing device) user entering a URL within a predefined domain from their workstation, entering user-specific information, and submitting the information, which will write the collected information to a secure database. The transmittal of configuration settings can be an automated or manual process per a schedule proscribed by the business customer IT Manager. The information of users' workstations within a group of computing devices, e.g., a company or logically defined portion of an organization (e.g., subsidiary, geographical location, and the like) will then be available to that company's IT Manager via a secure web site for viewing, querying, and reporting purposes. Links to the configuration database (system reference tool, SRT), upgrade information, updated drivers, specific component information and other related content will also be provided in the site. Accordingly, an aspect of the AMS is not only to provide a valuable service for business customers via a web site, but also provide an upsell avenue to generate additional revenue from existing clients of the host of the website. Furthermore, an AMS in accordance with the present invention can deflect telephone calls from customer support banks and increase customer satisfaction.

IT Manager profiles will be entered, managed, and maintained through a netware directory services (NDS) customer account profiles tool. The AMS includes functionality to allow business customer IT Managers to gather and view user, inventory, and system configuration information for all company-owned computing devices in multiple office locations, as well as “in the field” through a secure environment. The AMS also can associate customer and user information with personal computer inventory. The AMS can also provide links to non-DMI workstation data from a system configuration page, including purchase date, warranty expiration date, etc.

The AMS includes logic configured to provide secure access to IT Managers (customers) to view data, run reports, and extract data into a downloadable format (e.g., .cvs, .xls, and the like), and can associate configuration components with high-level OEM technical content.

The users of the AMS that may find it very useful are business customers of the host of the website, which may be the same as or associated with a computing device equipment manufacturer, and more particularly IT Managers who will access the system to inventory and review system configurations for all company-owned computing devices, e.g., personal computers or workstations. Although it is possible for consumers to have only one personal computer, the AMS of the present invention can be particularly useful for businesses with multiple systems in various office locations, as well as systems “in the field”.

PC Pit Stop provides a profiler, ActiveX control, which harvests configuration information from a system. According to the present invention, a profiler, such as PC Pit Stop, is embedded in a secure URL within a website that will harvest system information and write collected system configuration information and associated workstation user data to a secure database. This harvested data will be collected by the website host via an automated or manual process initiated by an IT Manager. The AMS includes logic configured to provide a user interface via a secure website to logically display the data, in accordance with a customer query, and provide relevant links to inventory and upgrade information at suitable sources of such assets. One aspect of the present invention includes that the inventory and upgrade information is information for these assets as available through the website host, i.e., the host of the AMS also is the supplier of the additional assets for the IT Manager.

The NDS profiles tool works with, or is incorporated into, the AMS to allow IT managers the ability to set-up and manage their own company's profiles, in addition to providing authentication for the AMS. In this context, the present invention includes, but is not limited to, associating more than one IT manager with each organization's set of computing devices.

The customer profile information that is collected for each company, which may be information about the company's IT Manager, includes at least one, and preferably more than one of the following data items: Account Information (Customer Name, User Name Customer ID); Billing Information (Name, Company Name, Address, City, State, Zip, Phone, Email); and whether the customer/user has previously signed up to be able to upgrade or update the computing device electronically

The following is a list of the specific information, at least one of which is preferably harvested by the profiler for each computing device (of course, the list is not exhaustive): System Serial Number (e.g. Serial Number: 0022176065); Model (e.g. Gateway Solo 9300 Pro (Notebook)); System Name (Network Name); Profile Date; BIOS Name, Version information, Date (e.g. Gateway 16.86 Nov. 1, 2000); CPU speed and manufacturer (e.g. Intel Pentium IV, 2.6 GHz); Maximum and total physical memory installed (e.g. 288MB (BIOS), 288MB (Windows)), Free Resources (e.g. 25% free resources), Memory slots (e.g. 3 memory slots, 1 free); Hard drive, including drive letter designation, total disk space, space available (e.g. C:\(FAT32) 19052MB total capacity, 14792MB free space; 1% fragmented (Scanned Dec. 13, 2001, Defragged May 20, 2001)); CD-ROM, including drive letter designation, model name (e.g. D:\CD-ROM) and model type; DVD, including drive letter designation, model Name; Floppy disk drive, including drive letter designation, model name; sound card (e.g. RAGE MOBILITY-M1 AGP (English)); Modem card (e.g., (modem) Actiontec 56K V.90 Modem); Network Devices (e.g. (net) Microsoft Dial-Up Adapter (net), 3Com FE575C-3Com 10/100 LAN CardBus-Fast Ethernet); Video adapter, chipset, memory, BIOS Version, BIOS Date, Video Resolution (e.g. 1024×768 pixels, 65,536 colors); Monitor Type; IP Address; MAC Address; Device Name (e.g. (net) Microsoft Dial-Up Adapter (net), 3Com FE575C-3Com 10/100 LAN CardBus-Fast Ethernet; Standard 101/102-Key or Microsoft Natural Keyboard (Apr. 23, 1999); Synaptics PS/2 TouchPad; Hewlett-Packard LaserJet 6L Printer (Apr. 23, 1999); Speakers/Speaker Driver; Version (e.g. Windows 98 SE (Windows 98 4.10.2222 A )); Product ID; software titles, including Microsoft Office, Word, Excel, Powerpoint, Outlook; Internet Default Browser; Default Mail Client; Anti-Virus Software Name and Version; AOL Version; GWUU.

The following data is particularly helpful so that the customer can track to whom an asset is assigned and where it is physically located: Name, Customer Identifier, System type (e.g., a dropdown menu including all models), and Location/Office.

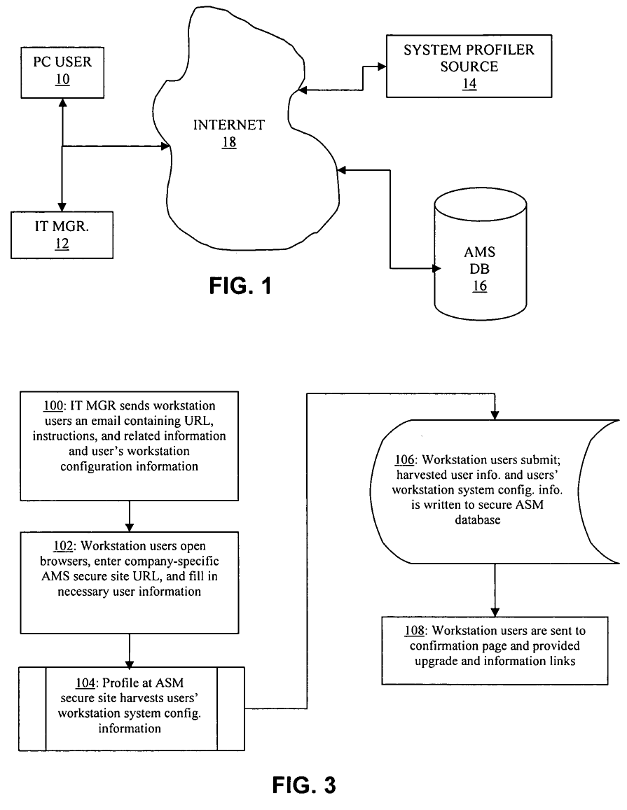

Turning now to the drawing figures, FIG. 1 schematically illustrates an exemplary embodiment of a system and method in accordance with the present invention. A computing device, e.g., a PC 10, is in communication with an IT Manager 12 associated with the same company, or more generally with the same organizational unit that uses an AMS of the present invention. A source of a profiler tool 14 is in communication with the user 10 through a network, preferably the Internet 18, as is an AMS database 16 which stores all data that is harvested by the profiler tool 14. The user 10 and the IT Manager 14 are illustrated in FIG. 1 to be in more direct communication (e.g., Ethernet LAN, WAN, etc.), while other aspects of the present invention include that they are in communication through the Internet 18. The source 14 of the profiler tool can be physically and/or logically and/or organizationally co-located with the AMS DB 16, while other aspects of the present invention include that the source 14 and DB 16 are at least in communication with each other, e.g., through the Internet 18.

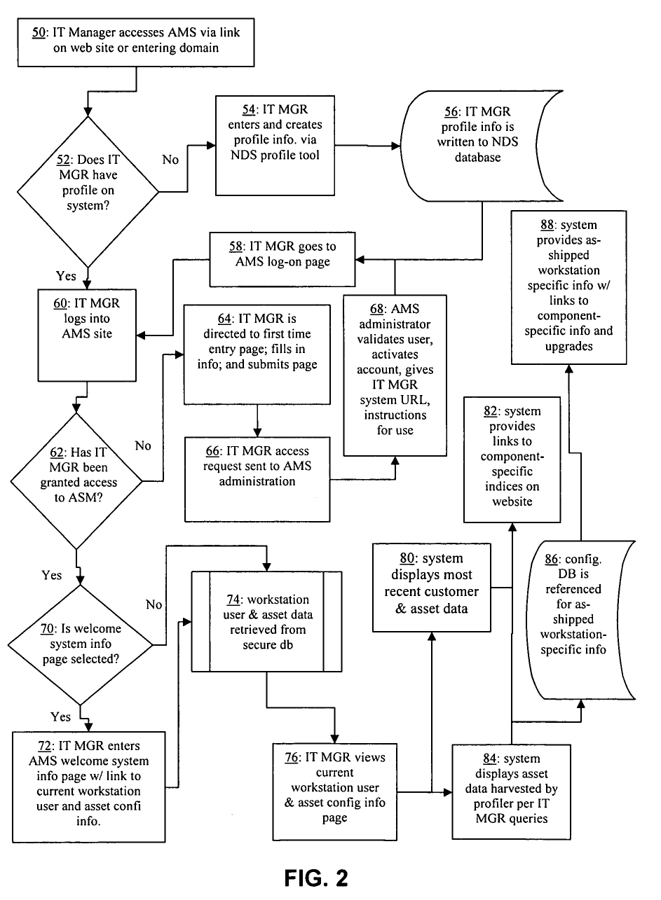

With further reference to FIG. 2, an exemplary process flow is diagrammatically illustrated. An IT manager accesses the AMS via a link on a host website or by entering a dedicated domain or portion of an internet domain (50). The IT manager is queried whether she has a profile on the AMS (52). If she does, the IT manager logs into the AMS site, which is preferably secure (60). If not, the IT manager enters and creates profile information using a NDS profile tool (54). The IT manager profile information is then written to a NDS database (56), and the IT manager go to an AMS log-on page (58), and proceeds to log in (60).

The IT manager is again queried, whether the IT manager has been granted access to the AMS (62). If she has not, the IT manager is directed to a first time entry page, she provides information, and submits the page and the information (64). The IT manager's access request is then sent to the AMS administration agent, e.g., via email, direct upload of form data, or the like (66). The AMS administration agent or administrator (person, group of persons, and/or logical process) validates the IT manager as a user of the AMS, activates the account, and provides her with a unique system URL, preferably with instructions for its use (68). The unique AMS URL is specific to that IT manager, and therefore for the set of computing devices for which she has responsibility, e.g., an entire company, portion of a company, or the like. The IT manager then is directed back to the login page (58) and proceeds.

If the IT manager has been granted access to the AMS, the records for her profile are queried to determine if she has requested that a welcome or system information page be displayed (70). If she has, then the IT manager enters the AMS welcome page with a link(s) to current workstation (e.g., company users 10) and asset configuration information (72). If she has not, the workstation user and asset data is retrieved from the AMS database (74). The IT manager then views the current workstation user and asset configuration information page (76), e.g., a high-level view will show four columns: Serial Number, Computer Name, User Name, and Last Profile date. At the option of the IT manager, the AMS can display the most recent customer data and high-level asset data (80), and/or the AMS can display asset data, in particular serial numbers, harvested by the profiler, in logical views and according to queries entered by the IT manager, which can also be formatted for printing and/or export in other formats (84). The AMS also optionally permits the IT manager to edit her account information, as well as perform searches of the data associated with her profile. The AMS then can provide links to component-specific indices on the host site, e.g., an OEM site or software and/or hardware supplier site (82). The AMS can also then reference a configuration database of as-shipped workstation-specific information, e.g., presented on a webpage as links embedded with the serial numbers of the workstations (86). The AMS can then provide as-shipped workstation specific information with links to component-specific information and upgrades (88).

Turning now to FIG. 3, another exemplary process flow is diagrammatically illustrated. The IT manager sends workstation users (within her organization) an email, or otherwise provides them with the information, containing the unique URL that the AMS has provided to her, as well as related information to capture user information and users' workstation configuration information (100). The workstation user(s) launch or open browser software on their workstation (e.g., Microsoft Internet Explorer, Netscape Navigator or Communicator, or the like), enters the company-specific AMS secure site URL, and fills-in user information (102). The profiler tool of the AMS secure site URL downloads to the workstation, and harvests the users' workstation system configuration information as detailed elsewhere herein (104); for this embodiment of the present invention, the browser software and/or the operating system are provided with helper applications, plug-ins, compilers, and the like necessary to permit the profiler to operate on the workstation. The workstation user then submits the configuration information that has been harvested by the profiler tool of the workstation, e.g., by clicking on a ‘submit’ button and the information is written to the AMS database for that company (106). For example, the data can be sent in an email, uploaded as form data, or similar methods that will be readily apparent to those of ordinary skill in the art. The workstation users then are optionally directed to a confirmation page and provided with upgrade information based on the configuration information that was just uploaded (108).

Another aspect of the present invention includes that each AMS system configuration page header will include a ‘view available upgrades’ link that will open up an index page on the website of the host entity (e.g., computing device's manufacturer) for that specific component, and/or the a login page to a ordering or shopping host website (which may be the OEM or another supplier).

Yet another aspect of the AMS of the present invention is the provision of an AMS administrators' entry page which will contain links to all companies that are currently managing assets through the AMS. In this context, the AMS administrator(s) are ‘Super Users’ in the system, which permits the host organization to monitor the usage of the AMS by one or more of its customers.

Thus, one aspect of an Asset Management System in accordance with the present invention includes a secure web application that allows an IT Manager of a company to remotely inventory all company computing devices' systems by sending a URL to the end users in her company. The end user accesses the URL, which takes them to a web page; the user accepts a profiler tool control, e.g., an ActiveX control for computing devices utilizing Microsoft Windows operating systems, which inventories the hardware and software on the device and sends it to a database housed at a host. In this manner, the IT manager can easily harvest and track the company's software and hardware assets.

Yet another aspect of the present invention is that IT managers and workstation users will receive a Thank You page after they submit their system configuration information to the AMS.

The foregoing description of aspects of the present invention includes descriptions of functions and processes, many of which involve the presentation of data to a user through browser software. Those of ordinary skill in the art are well acquainted with the build and operation of webpages and the databases which are associated with the data presented in the webpages.

According to a preferred embodiment of the present invention, the profiler tool is an ActiveX tool, the AMS host is a computing device manufacturer and/or distributor, and the IT manager(s) is (are) part of customer organizations that have purchased or leased personal computers from the AMS host.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

What is claimed is:

1. A method of managing computing device assets, comprising:
providing a profiler capable of retrieving data from a computing device representative of software, hardware, or both, of a computing device;
retrieving data from a plurality of computing devices using the profiler; and
collecting the retrieved data in a database.

2. A method in accordance with claim 1, further comprising:
communicating a URL to a user of a computing device, the URL pointing to a source of the profiler.

3. A method in accordance with claim 2, wherein communicating comprises emailing an URL.

4. A method in accordance with claim 1, wherein the profiler operates with browser software on the computing device.

5. A method in accordance with claim 1, further comprising:
establishing an account for a plurality of computing devices in the database; and
associating at least one IT manager with the account.

6. A method in accordance with claim 5, further comprising:
permitting the at least one IT manager to view all data in the database for said plurality of computing devices, query the database for data of at least one of said plurality of computing devices, or both.

7. A method in accordance with claim 1, wherein the computing device is in communication with a source of the profiler via the internet.

8. A system useful for managing computing device assets, comprising:
profiler means for retrieving data from a computing device representative of software, hardware, or both, of a computing device;
means for retrieving data from a plurality of computing devices using the profiler; and
means for collecting the retrieved data in a database.

9. A system in accordance with claim 8, further comprising:
means for communicating a URL to a user of a computing device, the URL pointing to a source of the profiler.

10. A system in accordance with claim 9, wherein the means for communicating comprises means for emailing an URL.

11. A system in accordance with claim 8, wherein the profiler means is for operating with browser software on the computing device.

12. A system in accordance with claim 8, further comprising:
means for establishing an account for a plurality of computing devices in the database; and
means for associating at least one IT manager with the account.

13. A system in accordance with claim 12, further comprising:
means for permitting the at least one IT manager to view all data in the database for said plurality of computing devices, query the database for data of at least one of said plurality of computing devices, or both.

14. A system in accordance with claim 8, further comprising:
the computing device and a source of the profiler means, wherein the computing device is in communication with the source of the profiler via the internet.

15. A system useful for managing computing device assets, comprising:
profiler logic configured to retrieve data from a computing device representative of software, hardware, or both, of a computing device;
logic configured to retrieve data from a plurality of computing devices using the profiler; and
logic configured to collect the retrieved data in a database.

16. A system in accordance with claim 15, further comprising:
logic configured to communicate a URL to a user of a computing device, the URL pointing to a source of the profiler.

17. A system in accordance with claim 16, wherein the logic configured to communicate comprises logic configured to email an URL.

18. A system in accordance with claim 15, wherein the profiler logic is configured to operate with browser software on the computing device.

19. A system in accordance with claim 15, further comprising:
logic configured to establish an account for a plurality of computing devices in the database; and
logic configured to associate at least one IT manager with the account.

20. A system in accordance with claim 19, further comprising:
logic configured to permit the at least one IT manager to view all data in the database for said plurality of computing devices, query the database for data of at least one of said plurality of computing devices, or both.

21. A system in accordance with claim 15, further comprising:
the computing device and a source of the profiler logic, wherein the computing device is in communication with the source of the profiler via the internet.
